(19) United States
(12) Patent Application Publication
(10) Pub. No.: US 2023/0322631 A1
(43) Pub. Date: Oct. 12, 2023

(54) PROCESS FOR PRODUCING SINTERED SILICON CARBIDE BODIES

(71) Applicant: NANOMAKERS, Rambouillet (FR)

(72) Inventors: Lauryanne TEULON, Versailles (FR); Yohan OUDART, Versailles (FR)

(21) Appl. No.: 18/043,384

(22) PCT Filed: Sep. 24, 2020
(86) PCT No.: PCT/IB2020/001011

§ 371 Date: Feb. 28, 2023

(51) Int. Cl. C04B 35/565; C04B 35/626

(52) U.S. Cl. CPC C04B 35/565; C04B 35/62665; C04B 35/6267; C04B 2235/3834; C04B 2235/5454

(57) ABSTRACT

A process for preparing a sintered silicon carbide body including
sintering a sample including silicon carbide particles to form a shaped sintered silicon carbide body, the particles containing a silicon carbide core and a surface layer containing carbon and oxygen, the sample having at least 90 weight % being C or Si and having a carbon to silicon molar ratio molC/molSi higher than 1 and a carbon in excess to oxygen molar ratio Cex/molO which is higher than 0.5 and lower than 5.3.

### TECHNICAL FIELD

The present invention concerns the process for producing sintered silicon carbide bodies with high density and the silicon carbide bodies produced by said process.

### STATE OF THE ART

Sintered silicon carbide is a promising material for many industrial applications for both structural and electrical purposes. The key properties of sintered silicon carbide can be cited are high temperature strength, high hardness which is the second only to diamond, low porosity, good wear resistance in sliding and abrasive environments, excellent corrosion resistance in most chemical environments, low thermal expansion and high thermal conductivity leading to excellent thermal shock resistance.

Due to these properties, sintered silicon carbide bodies are widely used in fabrication of components for automotive industry, aerospace manufacture, nuclear industry and in semiconductor application.

However, one of the main problems associated with the practical applications of SiC is the difficulty in densification because of its strong covalent bonding nature and low self-diffusivity. The bonding between Si and C atoms is mainly covalent, which makes it difficult to consolidate SiC.

Up to date, pure SiC can only be densified by sintering at high temperatures and pressures because of its highly covalent bonding nature. Moreover, it is in general considered that the addition of sintering additives is essential for enhancing the densification of SiC in reasonable temperature.

The commonly used methods for producing sintered silicon carbide comprise a step of initially mixing fine (sub-micron or nanoparticles) and pure silicon carbide powder with sintering additives. The powdered material is then formed or compacted by using most of the conventional ceramic forming processes such as die pressing, isostatic pressing and injection molding. Following the forming stage the material is sintered at high pressure and at high temperature, often nearby 1900° C.

Sintering additives used in prior art which can be cited include metallic sintering additives and non-metallic sintering additives.

Metallic sintering additives are those such as a metal, for example boron, aluminum, beryllium and a compound thereof such as Al₂O₃. However, the use of these additives could cause the contamination of sintered silicon carbide by the metals comprised in sintering additives, which is a problem for applications of sintered SiC in semiconductor industry for instance.

The level of density of a sintered silicon carbide body can be represented by its relative density, which is a ratio between measured density of sintered silicon carbide body obtained by Archimede method and theoretical density that is 3.21 g/cm³.

Indeed, the presence of pores in a sintered silicon carbide body reduces the density of said sintered body compared to theorical density. Thus, the higher the relative density of a sintered silicon carbide body, the less the sintered body contains pores. It is important to provide sintered silicon carbide body with a relative density the closest possible to 100%, since the pores in a sintered silicon carbide body can lead to poor thermal conductivity and sometimes even poor electrical conductivity. Moreover, the presence of pores in a sintered piece can also result in inhomogeneity of mechanical/thermal proprieties among different parts of the piece, while the homogeneity of these proprieties in one piece is crucial for most of industrial applications.

Non-metallic sintering additives are for example carbon black, graphite, or other organic compound which could provide an exterior carbon source.

For example, U.S. Pat. No. 6,090,733 described a method for preparing a sintered silicon carbide, said method including a step of sintering a mixture of a silicon carbide powder and a non-metallic auxiliary sintering agent, which is preferably a phenol resin of the resol type.

It is believed that the role of carbon in activating the process of SiC sintering is to block the mass transport processes which are ineffective in densification, to maintain proper dispersion of SiC grains (Stobierski and Gubernat, Ceramics International 29 (2003) 287-292) and to remove oxygen in SiC by forming volatile species.

However, these methods cannot provide sintered silicon carbide with high relative density. By the way, since these methods need the addition of exterior carbon source, the last one need a further step to homogenously disperse sintering additives with SiC particles.

These methods are laborious without being able to provide sintered SiC with satisfactory high relative density in a reasonable temperature and pressure.

Thus, it is still necessary to provide a new method which can produce sintered silicon carbide with a high density and/or a high purity and/or at a reasonable sintering temperature and/or at a reasonable sintering pressure preferably without the need of any exterior additive as auxiliary sintering agent or as dispersant.

### THE INVENTION

The first subject-matter of the present invention is to provide a method for producing a high-quality sintered silicon carbide body with higher relative density at a reasonable temperature and a reasonable sintering pressure without using any additive.

Against all odds, the Inventors of the present invention find out that a high relative density (preferably 98%) of sintered silicon carbide can be produced and that the use of additives such as sintering additives or dispersant can be exempted when a sample of particular type of silicon carbide particles is employed, wherein said particles have a silicon carbide core and a surface layer containing carbon and oxygen and said sample has at least 90 weight % being C or Si and has a molar ratio of carbon to silicon molC/molSi (where molC is the number of moles of atoms of Carbon in the sample and molSi is the number of moles of atoms of Silicium in the sample) higher than 1 and preferably a molar ratio of carbon in excess to oxygen Cₑₓ/molO (where molO is the number of moles of atoms of Oxygen in the sample) higher than 0.5 and lower than 5.3, preferably lower than or equal to 5, or even lower than or equal to 2.5.

The type of silicon carbide particles or the type of sample used in the process of the present invention has carbon in excess Cₑₓ (also noted Cex) in term of molar quantity with compared to silicon.

Cₑₓ=molC-molSi

With:
Cex the carbon in excess Cex in the sample in term of molar quantity with compared to silicon
molC the number of moles of Carbon C in the sample
molSi the number of moles of Silicium Si in the sample

Without being bound by theory, the presence of carbon in excess at the surface of said particle would enable the sintering reaction between each said particle in a reasonable temperature and pressure, that can be a temperature higher than 2100° C. and/or lower than 2400° C. and a pressure higher than 60 MPa and/or lower than 80 MPa.

It is reported that free carbon present in the particle would be involved in the elimination of oxygen contained in the particle, while oxygen impurities can accelerate the abnormal growth and coarsening of SiC grains during sintering (Feng et al., Ceramics International, Volume 45, Issue 18, Part A, 15 Dec. 2019, Pages 23984-23992). It was also already reported in U.S. Pat. No. 6,090,733 that excess quantity of free carbon in particle will decrease the density of sintered silicon carbide.

The present invention concerns a process for preparing a sintered silicon carbide body comprising a step of sintering of a sample comprising (or comprising at least 95% by weight or substantially consisting of or consisting of) silicon carbide particles to form a shaped sintered silicon carbide body, said sample having a carbon to silicon molar ratio molC/molSi higher than 1

In an embodiment of the invention, said process for preparing a sintered silicon carbide body comprises a step of:
sintering a sample comprising (or comprising at least 95% by weight or substantially consisting of or consisting of) silicon carbide particles to form a shaped sintered silicon carbide body, said particles containing a silicon carbide core and a surface layer containing carbon and oxygen, said sample having at least 90 weight % being C or Si and having a carbon to silicon molar ratio molC/molSi higher than 1 and preferably a carbon in excess (Cex) to oxygen molar ratio Cex/molO which is higher than 0.5 and lower than 5.3, preferably lower than or equal to 5, or even lower than or equal to 2.5.

The term “sintering” is referred to a thermal process consisting of heating a compacted solid mass of material during a given time at lower temperature than the melting point of the material. The high temperature leads to welding of particles between them to form one solid piece.

By “a sample consisting of silicon carbide particles” means a sample which does not contain other material which is not a silicon carbide particle.

By “silicon carbide particle” means a particle whose majority of chemical component is SiC according to the characterization of X-ray diffraction, TEM (Transmission electron microscopy), TEM-EDX (Transmission electron microscopy linked with energy-dispersive X-ray spectroscopy), XPS (X-ray photoelectron spectroscopy) and Raman spectroscopy applied to said particles according to the methods described in K. Shimoda et al, Colloids and Surfaces A: Physicochem. Eng. Aspects, 463, 93-100; 2014. A silicon carbide particle can further comprise a 3.0 very minor quantity of other components such as carbon, oxygen, nitrogen and/or a trace of metal element, such as Ni, Fe, Al.

Preferably, said silicon carbide particle has a metallic purity at least of 99%, more preferably 99.9%, still more preferable 99.99%.

By “silicon carbide particles containing a silicon carbide core and a surface layer containing carbon and oxygen” means silicon carbide particles which can be considered as having a SiC core and a surface layer according to the characterization of X-ray diffraction, TEM (Transmission electron microscopy), TEM-EDX (Transmission electron microscopy linked with energy-dispersive X-ray spectroscopy), XPS (X-ray photoelectron spectroscopy) and Raman spectroscopy applied to said particles according to the methods described in K. Shimoda et al, Colloids and Surfaces A: Physicochem. Eng. Aspects, 463, 93-100; 2014.

By “said sample having at least 90 weight % (or by weight) being C or Si” means that at least 90% of total weight of said sample are carbon or silicon. In another word, the weight fraction of carbon and silicon in said sample is at least 0.9.

By “said sample having at least X weight % (or by weight) being C or Si” means that at least X % of total weight of said sample are carbon or silicon. In another word, the weight fraction of carbon and silicon in said sample is at least X/100.

In a particular embodiment, said sample has at least 95 weight % being C or Si.

In a more particular embodiment, said sample has at least 98 weight % being C or Si.

The term “said sample having a carbon to silicon molar ratio molC/molSi higher than 1” is meant that the molar quantity of carbon atoms in said sample is more than the molar quantity of silicon atoms in the same particle. A such molC/molSi molar ratio is because of the carbon in excess in said sample which is due to the presence of a surface layer containing carbon in silicon carbide particles of said sample.

The symbol Cₑₓ is referred to the molar quantity difference between the molar quantity of carbon in said sample and the molar quantity of silicon in the same sample. As previously explained, Cₑₓ can be calculated by following equation: Cex=molC-molSi.

The term “carbon in excess to oxygen molar ratio Cₑₓ/molO” is referred to ratio between:
the molar quantity difference between the molar quantity of carbon in an aforementioned sample comprising silicon carbide and the molar quantity of silicon in the same sample, and
the molar quantity of oxygen in the same sample.

The molar ratios molC/molSi and Cₑₓ/molO of said sample comprising silicon carbide can be characterized by conventional elementary chemical analysis methods.

These ratios can be obtained by calculating mass concentrations of carbon, oxygen and silicon of said sample comprising silicon carbide.

For example, the carbon mass concentrations of a sample can be determined by converting carbon into carbon dioxide and carbon monoxide gases which are transported through oxygen to infrared detectors

The oxygen mass concentrations of a sample can be determined by transforming the material into gas under an inert carrier gas which are transported by the inert carrier gas to the appropriate infrared detectors.

The oxygen content of a sample can be controlled by monitoring the exposition of the particles to oxygen or by using oxygenated reagent.

The silicon mass concentrations of a sample can be determined by X-rays fluorescence.

According to a preferred embodiment of the process of the present invention, no additive is mixed with said sample consisting of silicon carbide particles to form a shaped sintered silicon carbide body.

Within the scope of the present application, the term “additive” is referred to any chemical compound which is not the silicon carbide particle containing a silicon carbide core and a surface layer containing carbon and oxygen.

The term “additive” is in particular referred to any sintering additives, any dispersants or any solvents.

The term “sintering additive” is referred to any metallic or non-metallic compound to enhance the densification of said particles comprising silicon and carbon or to reduce sintering temperature or pressure. Without being bound to theory, a sintering additive can react with particles to be sintered to reduce the grain boundary-surface energy ratio.

The term “dispersant” is referred to any cationic, anionic or non-charge surfactant to stabilize a dispersion of particles comprising silicon and carbon.

The term “solvent” is referred to water or a non-aqueous solvent which is used to form a dispersion or a slurry of particle comprising silicon and carbon.

The process of present invention is conducted without the need of any solvent or dispersant to form a shaped body.

Thus, the process of the present invention can avoid any step of mixing, blending, milling, kneading, pre-compaction or extrusion that is commonly used in methods of prior art to form a homogenous mixture of silicon carbide particles with additives and to form a shaped body before the sintering.

In a preferred embodiment of the invention, the silicon carbide particles are silicon carbide nanoparticles.

Said nanoparticles can have a particle diameter from 10 to 1000 nm, particularly from 10 to 200 nm, more particularly from 30 to 80 nm, more particularly said nanoparticles have an average mean particle size of 35 nm.

In particular, said nanoparticles can be nanowires having a diameter from 10 to 200 nm and a length from 100 to 1000 nm.

The size diameter of particle can be determined by the measurement of nanoparticle specific surface (SSA) and of their true density (d). Then the following formula is used: d(nm)=6000/(SSA in m²/g)/d (kg/L)

The specific surface is the ratio of the area of the surface of the particles and the quantity (in grams) of matter of the particles.

The nanoparticle specific surface can be measured by any method known in prior art, according to the theory of Brumauer, Emmet &Teller. For example, nanoparticle specific surface can be measured by adsorption of a gas, for example nitrogen gas, on the surface of a material of known mass. The principle is to measure a necessary quantity of nitrogen gas to have a single layer of this gas on the surface. Nanoparticle specific surface can be measured by the apparatus BELSORP-mini ii.

The nanoparticle true density (the mass of a particle divided by its volume, excluding pores) can be measured by any method known in prior art, such as by helium pycnometry.

Amorphous and/or alpha phase and/or beta phase silicon carbide nanoparticles can be used for the process of the present invention.

In a particular embodiment of the process of the invention, said silicon carbide particles are amorphous and/or beta and/or alpha phase silicon carbide nanoparticles.

In a more particular embodiment of the process of the invention, said silicon carbide particles are exclusively beta phase silicon carbide nanoparticles.

Said silicon carbide nanoparticles can be doped n-type by nitrogen or phosphorus for instance (with other elements possible) or p-type by beryllium, boron, aluminium, or gallium for instance (with other elements possible).

Silicon carbide nanoparticles can be produced from abrasive raw, for example from crushing crude silicon carbide material, or by any common de novo synthesis method, such as sol-gel process or laser pyrolysis process, such as the method described in WO2014009265.

The carbon excess of the silicon carbide particles used in the present invention can be obtained during particle synthesis process, for example during particle synthesis process by laser pyrolysis.

For example, silicon carbide nanoparticles with carbon in excess can be produced by laser pyrolysis, wherein the excess of carbon molar quantity compared to silicon (molC/molSi molar ratio higher than 1) is obtained during laser pyrolysis.

In particular embodiment, the sample comprising silicon carbide particles used in the process of the invention has:
a carbon to silicon molar ratio which is higher than 1.01 and/or lower than 1.5 and/or
a carbon in excess to oxygen molar ratio Cₑₓ/molO which is higher than 0.5 and/or lower than or equal to 5.

In a more particular embodiment, the sample comprising silicon carbide particles used in the process of the invention has:
a carbon to silicon molar ratio molC/molSi which is higher than 1.01 and lower than 1.5, and
a carbon in excess to oxygen molar ratio Cₑₓ/molO which is higher than 0.5 and lower than 5.3, preferably lower than or equal to 5, or even lower than or equal to 2.5.

In another embodiment, the sample comprising silicon carbide particles used in the process of the invention is a sample comprising (or comprising at least 95% by weight or substantially consisting of or consisting of) silicon carbide nanoparticles, said sample having a carbon to silicon molar ratio molC/molSi higher than 1 and a carbon in excess to oxygen molar ratio Cₑₓ/molO which is higher than 0.5 and lower than 5.3, preferably lower than or equal to 5, or even lower than or equal to 2.5.

In a more particular embodiment, the sample comprising silicon carbide particles comprising silicon and carbon used in the process of the invention is a sample comprising (or comprising at least 95% by weight or substantially consisting of or consisting of) silicon carbide nanoparticles, said sample having a carbon to silicon molar ratio molC/molSi which is higher than 1.01 and lower than 1.5 and a carbon in excess to oxygen molar ratio Cₑₓ/molO which is higher than 0.5 and lower than 5.3, preferably lower than or equal to 5, or even lower than or equal to 2.5.

Thanks to the use of a sample of silicon carbide particles having above explained specific range of molC/molSi molar ratio and Cₑₓ/molO molar ratio, the sintering step for obtaining a sintered silicon carbide body of the process of the present invention can be proceeded in a reasonable temperature and pressure, that can be:
at a temperature higher to 2100° C. and/or lower to 2400° C., in particular in a temperature from 2100° C. to 2300° C. and more particularly at 2200° C., and/or
at a pressure higher to 60 MPa and/or lower to 80 MPa, in particular at a pressure from 60 MPa to 80 MPa and more particularly at 65 MPa.

The sintering time of the process of the present invention can be varied according to the chosen sintering method, sintering temperature and pressure.

For example, when the sintering step of the process of the invention is spark plasma sintering under a temperature from 2100° C. to 2300° C. and a pressure from 60 MPa to 80 Mpa, the sintering time can be about 20 minutes.

In a preferred embodiment of the process of the present invention, the sintering step for obtaining a sintered silicon carbide body of the process of the present invention is Spark Plasma Sintering method preferably as that described in Hayun et al. Ceramics International 38 (2012) 6335-6340.

According to an embodiment, it is possible to use a suitable mold to give a desired form to the sintered silicon carbide body.

In this case, the process of the present invention can comprise, before the step of sintering, a step of filling a mold with above defined sample comprising (or comprising at least 95% by weight or substantially consisting of or consisting of) silicon carbide particles.

After the sintering, the sintered silicon carbide body is preferably cooled down, for instance in said protective gas or under vacuum to room temperature before being unmolded.

In a particular embodiment, the process of the present invention for preparing a sintered silicon carbide body comprises:
(a). filling a mold with the sample comprising (or comprising at least 95% by weight or substantially consisting of or consisting of) silicon carbide particles to form a shaped body, said particles containing a silicon carbide core and a surface layer containing carbon and oxygen, said sample having at least 90 weight % being C or Si and having a carbon to silicon molar ratio molC/molSi higher than 1 and a carbon in excess to oxygen molar ratio Cex/molO which is higher than 0.5 and lower than 5.3, preferably lower than or equal to 5, or even lower than or equal to 2.5,
(b). sintering the mold filled with said sample to obtain the shaped sintered silicon carbide body

In the step (a) of the process of the invention, the mold used to be filled with the particles comprising silicon and carbon should be preferably made by a material resistant to a temperature more than 2300° C. and a pressure more than 80 MPa. Suitable material can be cited are graphite or alpha phase silicon carbide.

Said mold can be jacketed with a flexible foil for ensuring electric contact between the mold and the shaped body to be sintered. Graphite powders can also be further sprayed on the flexible foil.

In the step (b) of the process of the invention, the sintering of the mold filled with particles comprising silicon and carbon can be pressureless sintering or any common pressure-assisted sintering method, such as hot pressing, hot isostatic pressing, gas pressure sintering, or spark plasma sintering.

Pressure-assisted sintering method can be conducted with the use of a protective gas, such as argon, helium, or under vacuum.

According to a particular embodiment, the process for sintering of a silicon carbide body of the present invention does not comprise a pre-compaction step of the sample before step (a).

In another embodiment, the desired form of the sintered silicon carbide body can be obtained with the help of a continuous device, such as two continuous rollers, which can shape a silicon carbide body during the sintering of silicon carbide particles.

Another subject-matter of the present invention is to provide a sintered silicon carbide body produced by the process of the invention for sintering of a silicon carbide body.

Said sintered silicon carbide body has a high relative density which is at least 98%, especially at least 98.5%, more especially at least 99%.

Compared to the methods known in prior art using different kinds of sintering additives, such as the method described in U.S. Pat. No. 6,090,733, the density of the sintered silicon carbide bodies obtained by the process of the present invention is higher and closer to theorical density.

Density of the sintered silicon carbide is measured with the Archimedes method (for instance ASTM B962-17).

This high density means that the sintered body has less pores and a more homogeneous structure, that guarantees better mechanical, thermal and electrical proprieties of the sintered silicon carbide bodies of the present invention.

By the way, thanks to the absence of any additive, dispersant, solvent during the process, the sintered silicon carbide body obtained from the process of the present invention has a higher purity and less undesired contamination.

Said sintered silicon carbide body having a higher relative and purity can find large applications as support used in semiconductor industry, as sputtering target in optic devices, mechanical bearing.

The present invention provides also another process for preparing a sintered silicon carbide body.

Said process comprises a step of sintering a sample comprising (or comprising at least 95% by weight or substantially consisting of or consisting of) silicon core carbon shell particles to form a shaped sintered silicon carbide body, said sample has a carbon to silicon molar ratio molC/molSi higher than 1.

Particularly, said process comprises a step of sintering a sample comprising (or comprising at least 95% by weight or substantially consisting of or consisting of) silicon core carbon shell nanoparticles to form a shaped sintered silicon carbide body, said sample having at least 90 weight % being C or Si and having a carbon to silicon molar ratio molC/molSi higher than 0.02 and preferably 1 and a carbon in excess to oxygen molar ratio Cex/molO which is higher than 0.5 and lower than 5.3, preferably lower than or equal to 5, or even lower than or equal to 2.5.

Silicon core carbon shell nanoparticles can be produced by any common method, such as laser pyrolysis (ref U.S. Ser. No. 10/611,643B2).

Silicon core carbon shell nanoparticles can be characterized by conventional analytic methods, such as X-ray diffraction, TEM, TEM-EDX, XPS and Raman spectroscopy applied to said particles according to the methods described in K. Shimoda et al, Colloids and Surfaces A: Physicochem. Eng. Aspects, 463, 93-100; 2014.

Said Si-core-C-shell nanoparticles further comprises oxygen and eventually nitrogen and a trace of metal elements.

molC/molSi ratio and Cex/molO ratio of said sample comprising (or comprising at least 95% by weight or substantially consisting of or consisting of) Si-core-C-shell nanoparticles can be determined by calculating mass concentration of C, Si and O of said sample.

Particularly, the sample comprising (or comprising at least 95% by weight or substantially consisting of or consisting of) silicon core carbon shell nanoparticle used in the said process is a sample having a carbon to silicon molar ratio molC/molSi which is higher than 1.01 and lower than 1.5 and a carbon in excess to oxygen molar ratio Cₑₓ/molO which is higher than 0.5 and lower than or equal to 5.

The present invention is illustrated in more detail by the following examples.

Materials and Methods

Carbon Mass Concentrations Analysis:

The carbon mass concentrations of a sample of silicon carbide particles are determined on an instrument EMIA320 from Horiba by melting the material under oxygen gas in induction furnace with high temperature (about 1600° C.). Carbon is converted into carbon dioxide and carbon monoxide gases which are transported through oxygen to infrared detectors. The measurement is then carried out by integrating the absorption in the infrared of the dioxide and carbon monoxide. The analyzed samples are in form of powder and do not require any specific mechanical or chemical preparation. For each sample, at least three test samples are taken under the same test conditions. The average of these three tests is the result of the analysis

Oxygen Analysis:

The oxygen mass concentrations of a sample are determined by melting the material under an inert gas (argon or helium) into an electrode furnace (temperature up to 2500-2900° C.). The gases released during the melting of the sample are transported by the inert carrier gas to the appropriate infrared detectors. The analyzed samples are in form of powder and do not require any specific mechanical or chemical preparation. as the melting of these materials is carried out at high temperature (>2000° C.), a nickel basis is required to facilitate the melting and removal of Oxygen gas to quantify. To do this, a test portion between 30 and 100 mg maximum is inserted into a nickel capsule during each analysis. For each sample, three test portions are made under the same analysis conditions as the calculation of the blanks and the calibration of the apparatus. The average of these three tests is the result of the analysis.

Silicon Analysis:

The analyzed samples are in form of powder and do not require any specific mechanical or chemical preparation. This powder is compacted as a pellet on a bed of boric acid coating. Analysis is performed by X-rays fluorescence. Analyses are carried out on a spectrometer PW2404 from PANalytical. The pellet sample is placed in the instrument for measurement. After study of the obtained fluorescence spectrum, the quantification of the elements is carried out.

### COMPARATIVE EXAMPLE 1

A comparative example is carried out according to the method described in U.S. Pat. No. 6,090,733.

A detailed description of the manufacturing process is described below:

6 g of a phenol resin of the resol type containing an amine (the fraction of residual carbon after thermal decomposition: 50%) and 94 g of a powder of a high purity n-type·beta-silicon carbide (silicon carbide is occasionally referred to as SiC, hereinafter) having an average particle diameter of 0.5 μm and one peak in the particle size distribution were mixed together in 50 g of ethanol or acetone used as the solvent using a wet ball mill. The resulting mixture was dried and formed in a cylindrical shape having a diameter of 20 mm and a thickness of 10 mm. The formed product contained 6% by weight of the phenol resin, 0.1% by weight of the amine, and 1,000 ppm of nitrogen.

The formed product was sintered in accordance with the hot press process with resistance heating at a pressure of 68 MPa in an argon atmosphere at a temperature of 2,300° C. for 3 hours to obtain a sintered silicon carbide. Physical properties of the sintered silicon carbide obtained were measured in accordance with the following methods.

The results of the measurements showed that the sintered silicon carbide obtained above had a relative density 97.5%.

### EXAMPLE 1 OF INVENTION

Silicon carbide powders used in this example are high-purity n-type, beta-silicon carbide (SiC) nanopowders obtained by a laser pyrolysis process with an average particle diameter of 35 nm and one peak in the particle size distribution. The weight fraction of carbon and silicon in said samples of silicon carbide powders is 98.8 weight %. The oxygen mass concentration of said sample is 1.2 weight %. The SiC nanopowders have a molar carbon to silicon ratio (molC/molSi) of 1.03, meaning a carbon in excess content of 3 molar %, and a molar carbon in excess to oxygen ratio (Cₑₓ/molO) of 1.0. The SiC nanopowders were placed into a graphite mold jacketed with a flexible graphite foil (Papyex® type for example) with a cylindrical shape and a diameter of 20 mm.

The filled graphite mold is placed in a Spark Plasma Sintering (SPS) machine. SiC nanopowders are flash sintered at a pressure of 65 MPa under vacuum at a temperature of 2200° C. for 20 min. Density of the sintered part is measured with the Archimedes method. Result showed that the sintered silicon carbide obtained above has a relative density of 98.1%.

When the sintered product obtained in this Example is compared with the sintered product obtained in Comparative Example 1, the use of silicon carbide nanopowders with an excess of carbon and a carbon in excess to oxygen ratio of 1.0 allows to obtain a denser product by using a lower sintering pressure along with a lower sintering temperature.

### EXAMPLE 2 OF INVENTION

The experiment was conducted in the same manner as in Example 1, except that the silicon carbide nanopowders have a molar carbon to silicon ratio (molC/molSi) of 1.04, meaning a carbon in excess content of 4 molar %, and a molar carbon in excess to oxygen ratio (Cₑₓ/molO) of 2.5. The weight fraction of carbon and silicon in said samples of silicon carbide powders is 99.34 weight %.

The oxygen mass concentration of said sample is 0.66 weight %.

The obtained sintered product had a relative density of 99.3%, which is a denser product compared to the product of Comparative Example 1.

### COMPARATIVE EXAMPLE 2

This comparative example was carried out to evaluate the impact of molar carbon in excess to oxygen ratio (Cₑₓ/molO) to the density of sintered silicon carbide.

The experiment was conducted in the same manner as in Example 1 of invention, except that the silicon carbide nanopowders have a molar carbon to silicon ratio (molC/molSi) of 1.05, meaning a carbon in excess content of 6 molar %, and a molar carbon in excess to oxygen ratio (Cₑₓ/molO) of 5.3. The weight fraction of carbon and silicon in said samples of silicon carbide powders is 99.5 weight %. The oxygen mass concentration of said sample is 0.35 weight %.

The obtained sintered product had a relative density lower than 97%.

This result suggests that the use of silicon carbide nanopowders with an excess of carbon and a carbon in excess to oxygen ratio higher than 5.3 would not be benefit for improving sintered silicon carbide density.

1. A process for preparing a sintered silicon carbide body comprising a step of:
Sintering a sample comprising silicon carbide particles to form a shaped sintered silicon carbide body, said particles containing a silicon carbide core and a surface layer containing carbon and oxygen, said sample having at least 90 weight % being C or Si and having a carbon to silicon molar ratio molC/molSi higher than 1 and a carbon in excess to oxygen molar ratio Cex/molO which is higher than 0.5 and lower than 5.3.

2. The process according to claim 1, wherein no additive is mixed with said sample comprising silicon carbide particles to form a shaped sintered silicon carbide body.

3. The process according to claim 1, wherein said sample comprising silicon carbide has:
a carbon to silicon molar ratio which is higher than 1.01 and/or lower than 1.5; and
a carbon in excess to oxygen molar ratio Cₑₓ/molO which is higher than 0.5 and/or lower than or equal to 5.

4. The process according to claim 1, wherein the carbon excess of the sample comprising silicon carbide particles is obtained during particle synthesis process.

5. The process according to claim 1, wherein said silicon carbide particles are silicon carbide nanoparticles.

6. The process according to claim 1, wherein said silicon carbide nanoparticles have a particle diameter from 10 to 1000 nm.

7. The process according to claim 1, wherein said silicon carbide nanoparticles are nanowires having a diameter from 10 to 200 of nm and a length from 100 to 1000 nm.

8. The process according to claim 1, wherein said particles comprising silicon and carbon are amorphous and/or beta and/or alpha phase silicon carbide nanoparticles, in particular beta phase silicon carbide nanoparticles.

9. The process according to claim 8, wherein said silicon carbide nanoparticles are produced by laser pyrolysis, wherein the carbon to silicon molar ratio higher than 1 is obtained during laser pyrolysis.

10. The process according to claim 1, wherein the sintering is proceeded with particles comprising silicon and carbon:
at a temperature higher to 2100° C. and/or lower to 2400° C.; and
at a pressure higher to 60 MPa and/or lower to 80 MPa,
to obtain a sintered silicon carbide body.

11. The process according to claim 1, wherein the step of sintering is Spark Plasma Sintering.

12. The process according to claim 1, comprising:
(a). filling a mold with the sample comprising silicon carbide particles to form a shaped body, said particles containing a silicon carbide core and a surface layer containing carbon and oxygen, said sample having at least 90 weight % being C or Si and having a carbon to silicon molar ratio molC/molSi higher than 1 and a carbon in excess to oxygen molar ratio Cex/molO which is higher than 0.5 and lower than 5.3 and
(b). sintering the mold filled with said sample to obtain the shaped sintered silicon carbide body.

13. The process according to claim 12,
wherein said process does not comprise a pre-compaction step of the sample before step (a).

14. A sintered silicon carbide body produced by a process according to claim 1.

15. The sintered silicon carbide body according to claim 14, wherein the relative density of said sintered body is at least 98%.
